(19) United States
(12) Patent Application Publication
(10) Pub. No.: US 2026/0321009 A1
(43) Pub. Date: Oct. 15, 2026

(54) CONTROL SYSTEM AND METHOD FOR PART ASSEMBLY WORKSTATION

(71) Applicant: TE Connectivity Solutions GmbH, Schaffhausen (CH)

(72) Inventors: Shu WANG, Middletown, PA (US); Geoffrey DYBICZ, Plymouth, MN (US); Xinping DENG, Middletown, PA (US); Roberto Francisco-Yi LU, Middletown, PA (US); Yiyun FEI, Middletown, PA (US); Pranav JADHAV, Plymouth, MN (US); Jeremy Ty LU, Plymouth, MN (US); Alexandre Apollinaire SAUQUET, Plymouth, MN (US); Kevin Tianwei HUANG, Plymouth, MN (US)

(21) Appl. No.: 19/178,184

(22) Filed: Apr. 14, 2025

(51) Int. Cl. G06V 20/40; G06T 7/60; G06T 7/90; G06V 10/25; G06V 40/10

(52) U.S. Cl. CPC G06V 20/49; G06T 7/60; G06T 7/90; G06V 10/25; G06V 40/107

(57) ABSTRACT

A method of controlling a part assembly workstation for assembling parts includes imaging an assembly area of the part assembly workstation with at least one imaging device to create a video of the assembly area during assembly processes. The method defines action regions in the video. The action regions are subsets of the assembly area. The method detects objects in the assembly area of the video and segments the video into action clips based on locations of the detected objects relative to the defined action regions.

### BACKGROUND OF THE INVENTION

The subject matter herein relates generally to part assembly workstations.

In many manufacturing environments, complex parts are assembled, either manually or by automated assembly processes. The part may be assembled at different workstations by different operators performing the same or different assembly tasks. Some systems use vision systems to capture video data of the assembly process, which is then analyzed to optimize the manufacturing processes or compare the efficiency of different operators. The video data is typically segmented into relevant clips that correspond to specific stages of assembly. This segmentation process is typically performed manually by engineers who review the footage and extract meaningful segments for further inspection. This manual approach is both time-consuming and prone to operator air, as it relies on human judgment to identify key events accurately. The process can result in inconsistencies due to variations in perception, fatigue, oversight, leading to inefficiencies in diagnosing assembly issues and implementing corrective actions.

The increasing complexity of manufacturing workflows and the growing volume of video data exacerbate these challenges. The demand for faster, more precise, and automated methods for video segmentation and part assembly is important to improving efficiency, reducing errors, and enhancing overall quality control.

### BRIEF DESCRIPTION OF THE INVENTION

In one embodiment, a method of controlling a part assembly workstation for assembling parts is provided. The method includes imaging an assembly area of the part assembly workstation with at least one imaging device to create a video of the assembly area during assembly processes. The method defines action regions in the video. The action regions are subsets of the assembly area. The method detects objects in the assembly area of the video and segments the video into action clips based on locations of the detected objects relative to the defined action regions.

In another embodiment, a control system for a part assembly workstation is provided and includes an imaging device at an assembly area of the part assembly workstation where parts are assembled to create a product. The imaging device creates a video of the assembly area during the assembly processes. The control system includes a video analysis tool that has one or more processors configured to define action regions in the video. The action regions are subsets of the assembly area. The imaging device includes an object detection tool that has one or more processors configured to detect objects in the assembly area of the video. The imaging device includes a video segmenting tool that has one or more processors configured to segment the video into action clips based on locations of the detected objects relative to the defined action regions.

In a further embodiment, a part assembly workstation is provided and includes an assembly area where parts are assembled to create a product. The part assembly workstation includes an imaging device at the assembly area. The imaging device creates a video of the assembly area during the assembly processes. The part assembly workstation includes a control system receiving the video from the imaging device. The control system includes a video analysis tool, an object detection tool, and a video segmenting tool. the video analysis tool has one or more processors configured to define action regions in the video. The action regions are subsets of the assembly area. The object detection tool has one or more processors configured to detect objects in the assembly area of the video. The video segmenting tool has one or more processors configured to segment the video into action clips based on locations of the detected objects relative to the defined action regions.

### BRIEF DESCRIPTION OF THE DRAWINGS

FIG. 1 shows a part assembly workstation 100 in accordance with an exemplary embodiment.

FIG. 2 illustrates the control system 200 for the part assembly workstation 100 in accordance with an exemplary embodiment.

FIG. 3 illustrates the control system 200 for the part assembly workstation 100 in accordance with an exemplary embodiment.

FIG. 4 is a flow chart showing a method 400 of controlling a part assembly workstation in accordance with an exemplary embodiment for assembling parts.

### DETAILED DESCRIPTION OF THE INVENTION

Embodiments described herein relate to video-based analysis for manual assembly action video segmentation for part assembly at a part assembly workstation(s). A control system controlling operations for the part assembly workstation performs the video-based analysis and may use artificial intelligence (AI) technology to aid in video segmentation. Assembly process analysis helps operations optimization by understanding operator behavior patterns and action cycle time. The assembly process analysis may take multiple times the duration of a video for operations cycle time data collection. The assembly process analysis and/or video segmentation can benefit manufacturers to interpret human actions within the production environment. For example, the video segmentation may be used for training or rebalancing of workstations to improve overall assembly line yield. The video segmentation may be analyzed to determine timing of actions or tasks. The video segmentation may be analyzed to compare efficiency of operators. The video segmentation may be analyzed to identify various actions and/or to identify wasted or inefficient steps in the assembly process.

Various embodiments described herein include an AI-based region-triggering method for manual assembly action segmentation to assist engineers with manufacturing process analysis. The automated assembly action segmentation may greatly reducing labor hours spent on cycle time data collection. The automated assembly action segmentation may segment manual assembly operations videos into different video clips, with each representing a distinct action. With these video clips, engineers can analyze action clips in detail to optimize the manufacturing processes.

Various embodiments described herein may include (i) an object detection model that detects and localizes key objects (for example, the left and right hands of the operator and/or part(s) and/or tool(s) used in assembly) in video frames, and/or (ii) a video analysis tool that allows users to define action regions to determine when an action commences and concludes, and/or (iii) a control algorithm that segments the videos into different action clips based on defined regions and detected object location.

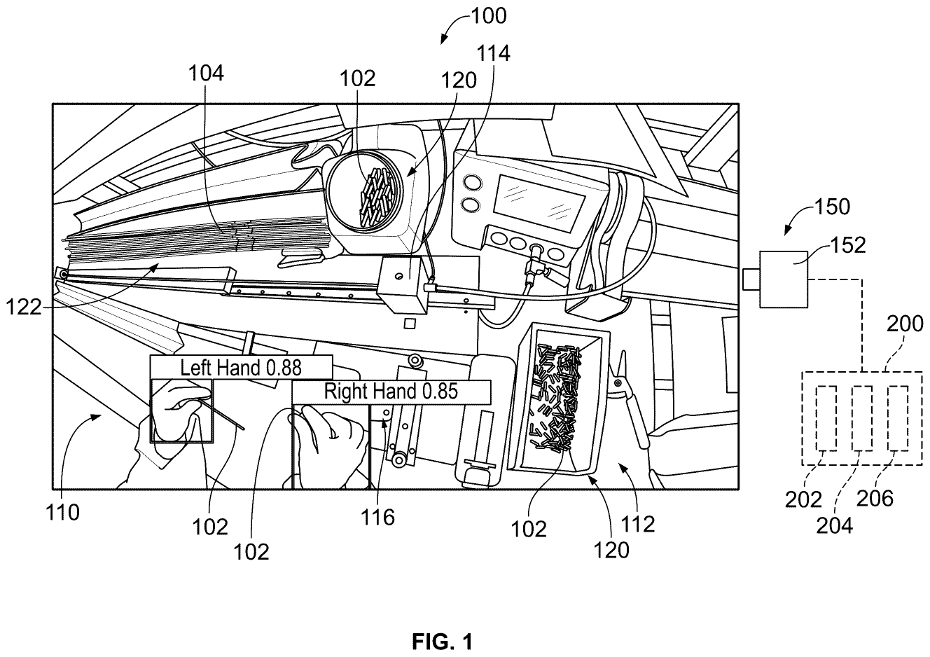

FIG. 1 shows a part assembly workstation 100 in accordance with an exemplary embodiment. The part assembly workstation 100 includes an assembly area 110 where parts 102 are assembled to create a product 104. The parts 102 and/or the product 104 may be referred to as workpieces or objects. The part assembly workstation 100 may be used for manufacturing various types of products, such as electrical connectors, medical devices, or other types of products. The part assembly workstation 100 includes a control system 200 controlling operations for the part assembly workstation 100. In an exemplary embodiment, the control system 200 provides video-based analysis for the part assembly process at the part assembly workstation 100.

In an exemplary embodiment, the part assembly workstation 100 includes a support structure 112 at the assembly area 110 for supporting other components. The support structure 112 may include a table, frame, a fixture, an assembly mandrel, or other support structures. The parts may be assembled at the assembly area 110 above the support structure 112. In various embodiments, the part assembly workstation 100 includes a holder 114 for holding one or more of the parts 102 or the product 104 during assembly. The holder 114 may include a fixture or mandrel for holding the part 102 at a fixed location in the assembly area 110, such as for assembling other parts with the part 102. In various embodiments, the part assembly workstation 100 includes an assembly tool 116 used to aid in assembly of the parts 102. The assembly tool 116 may be used for inserting one part into another part. The assembly tool 116 may be used for securing or fixing parts together, such as for crimping, soldering, welding, or otherwise securing the parts. The assembly tool 116 may be used for forming one or more of the parts. Other types of assembly tools may be used in alternative embodiments.

In various embodiments, the part assembly workstation 100 includes part storage 120 for storing the parts 102. For example, the part storage 120 may include storage bins, a storage tray, a storage reel, or other types of part storage components. In various embodiments, the part assembly workstation 100 includes product storage 122 for storing the products 104 after assembly. For example, the product storage 122 may include bins, a tray, a reel, or other types of product storage components.

In an exemplary embodiment, the part assembly workstation 100 includes one or more imaging devices 150 at the assembly area 110. The imaging device 150 may be mounted to the support structure 112. In an exemplary embodiment, the imaging device 150 includes a camera 152. The imaging device 150 generates a video of the assembly area 110 during the assembly process for analysis, such as to optimize the manufacturing process. The entire assembly area 110 may be the target of inspection, or only a part of the assembly area 110 may be the target of the inspection. The assembly area 110 may include a plurality of targets of inspection which may be imaged by one of the imaging devices 150 or by different imaging devices 150. The resulting images/video may include a plurality of target objects, which may be analyzed by either manual analysis or AI/vision based analysis for video segmentation into action clips corresponding to assembly actions/tasks. The imaging device(s) 150 may image the assembly area from multiple angles. The imaging device(s) 150 may image multiple assembly tasks, such as at different regions of the assembly area 110 or different assembly areas 110. In an exemplary embodiment, the imaging device 150 creates a video of the assembly area 110 during the assembly processes. The imaging device 150 may be a digital camera for generating digital images. The imaging device 150 may include a machine vision camera, such as an area scan camera. The imaging device 150 may include a CCD camera, a CMOS camera, or other type of camera. The imaging device 150 may generate a monochrome image or a color image. In other various embodiments, the imaging device 150 may include a thermal camera for generating thermal images or other type of imaging device.

In an exemplary embodiment, the control system 200 is operably coupled to the imaging device 150. The control system 200 receives the video from the imaging device 150 for analysis of the assembly processes. In an exemplary embodiment, the control system 200 includes a video analysis tool 202, an object detection tool 204, and a video segmenting tool 206. The video analysis tool 202 is configured to define action regions in the video. The object detection tool 204 is configured to detect objects in the assembly area 110 of the video. The video segmenting tool 206 is configured to segment the video into action clips based on locations of the detected objects relative to the defined action regions for analysis.

In an exemplary embodiment, the system is designed for AI-based region-triggering video analysis of manual part assembly action segmentation to assist engineers with manufacturing process analysis. The system prepares a set of video data for target actions. In various embodiments, the operator may use the video analysis tool 202 to specify action regions within the video. The action regions may be manually set by the operator (for example, location, size, shape, etc.) in the video. Alternatively, the action regions may be automatically detected and set by performing video analysis to identify specific regions in the video where repeated tasks occur. The action regions are regions or sub-areas, within the assembly area 110, where one or more assembly steps occur. The action regions may be areas where the operators hands are located during an assembly task. The action regions may be areas where fixtures or assembly tools are located and where assembly of the parts occurs.

In various embodiments, the operator may define start and stop conditions for each action. For example, the operator may use the video analysis tool 202 to define the start and stop conditions. The start and stop conditions may be defined based on locations of the operators hands (for example, the hands may move into or out of a region to perform various tasks). In various embodiments, an action commences when both hands appear in a defined action region (for example, at the center of the frame) and concludes when one or more of the hands moves out of the action region (for example, the left hand moves to the upper left corner).

In an exemplary embodiment, the object detection tool 204 is trained to identify objects within the video to distinguish different actions. For example, the object detection tool 204 may be trained to identify the left and right hands and/or to identify the workpieces and/or to identify assembly tools. The object detection tool 204 may track movements of the objects within the video. In an exemplary embodiment, the control system performs an object detection analysis (for example, object detection algorithm) of the video to obtain bounding box positions of the objects (for example, the hands) in each frame.

In an exemplary embodiment, the video segmenting tool 206 performs video segmentation to segment the video into different action clips of the various assembly tasks. The action clips may be based on the predefined action regions and the detected object positions. The action clips present different actions. The action clips can be for different usage scenarios, such as cycle time estimation, or training an action segmentation AI model.

In an exemplary embodiment, the control system 200 has several features to help users define the regions and action start and stop conditions. The user may determine or define the number of action regions. For example, the user can specify a single action region or multiple action regions for actions/tasks to start or stop. The user may determine or define object classifications, such as the type of object (for example, hands, workpieces, tools, and the like). For example, the user can define hand classification, such as right hand, left hand, and the like to differentiate tasks based on which hand is performing the task. The user can specify the trigger of one region to be either: left hand, right hand, both hands, or any hand. The user may determine or define a task duration to qualify as an identified task. For example, the user can specify how many frames the hand(s) need to stay in the action region for the trigger. The user may determine or define a leniency threshold. For example, the user can specify the proportion of the satisfied number of frames to trigger the region. For instance, if the lenience is 0.8, and the number of frames is 10, then as long as the satisfied number of frames is equal to or larger than 8, the action can be triggered. The user may determine or define an overlap threshold to determine an amount of overlap of the object (for example, hand) with the action region to define how much portion of a hand enters the region to be considered valid for a frame. The video segmentation occurs to define the action clips based on the designated features.

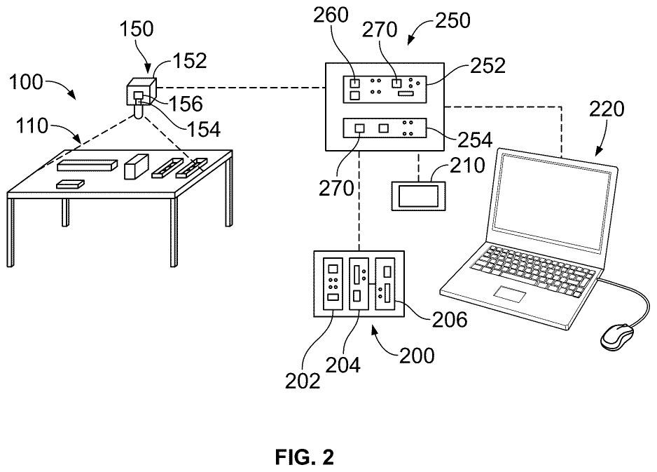

FIG. 2 illustrates the control system 200 for the part assembly workstation 100 in accordance with an exemplary embodiment. The control system 200 is configured to perform video-based analysis for video segmentation of tasks/actions within the production environment to improve the assembly process. For example, the video segmentation may be used for training or rebalancing of workstations to improve overall assembly line yield. The video segmentation may be analyzed to determine timing of actions or tasks and/or to compare efficiency of operators and/or to identify various actions and/or to identify wasted or inefficient steps in the assembly process.

The control system 200 includes the imaging device(s) 150, a display device 210, a personal computer 220, and a control unit 250. The personal computer 220 may be omitted. Various information and images can be displayed by using the personal computer 220 instead of the display device 210. It has been illustrated in FIG. 2 that the control unit 250, the imaging device 150, the display device 210, and the personal computer 220 are described as separate units as an example of an embodiment of the control system 200, but a plurality of components thereof may also be combined and integrated. For example, the display device 210 and the personal computer 220 can be integrated, or the control unit 250 and the imaging device 150 can be integrated, or the control unit 250 and the display device 210 can be integrated or the control unit 250 and the personal computer 220 can be integrated. The control unit 250 may be divided into a plurality of units, and a part of the divided units may be incorporated in the imaging device 150 or the display device 210 or the personal computer 220. Alternatively, the imaging device 150 may be divided into a plurality of units, and a part of the divided units may be incorporated in another unit.

The imaging device 150 includes the camera(s) 150 and may include an illumination module (not shown). The imaging device 150 is operated to acquire images of the inspection target at the assembly area 110. The imaging device 150 may include a motor 154 that drives an imaging optical system and an imaging board 156. The motor 154 is a part that automatically performs focus adjustment by driving a lens of the camera 152, and can perform focus adjustment by a method such as contrast autofocus. An imaging visual field range (imaging region) using the camera 152 is set so as to include the inspection target. The imaging board 156 may include one or more electrical components mounted thereto, such as processors, IC components, a CMOS sensor, a field programmable gate array (FPGA), a digital signal processor (DSP), and the like. The components of the imaging device 150 may include light receiving elements for receiving light incident from the imaging optical system. The CMOS sensor is an imaging sensor configured to acquire a color image. For example, a light receiving element such as a CCD sensor may be used instead of the CMOS sensor. The FPGA and the DSP are used for executing image processing within the imaging device 150, and a signal output from the CMOS sensor is also input to the FPGA and the DSP.

The control unit 250 may include a main board 252, a communication board 254, and may include other boards, such as a power board. One or more electrical components, such as a processor, an FPGA, a DSP, a memory, and the like are mounted on the main board 252. The components of the main board 252 control operations of the various connected boards and modules. For example, the control unit may output control signal for controlling the imaging device 150, the display device 210, the personal computer 220, or other components. The control unit may output control signals for controlling the CMOS sensor of the imaging board 156 of the camera 152, such as to start or stopping imaging and controlling imaging. When the imaging is ended, an image signal output from the imaging device 150 is input to the control unit 250, such as to the FPGA of the main board 252, is processed by the FPGA and the DSP of the main board 252, and is stored in the memory of the main board 252. The communication board 254 outputs signals, such as image data, an analysis output, or other results, to a user interface, such as the display device 210 and/or the personal computer 220. The communication board 254 may receive inputs from a user interface, such as a touch panel of the display device 210 and/or the personal computer 220, a keyboard of the personal computer 220, an input device, such as a pointer device, of the personal computer 220. Communication may be wired or wireless.

In an exemplary embodiment, the control unit 250 includes one or more storage devices, such as one or more memories 260. The memory 260 may include a hard disk drive. The memory 260 stores one or more program files (software) for causing control and processing to be executable by the hardware. For example, the program file can be stored in a storage medium such as an optical disk, and the program file stored in the storage medium can be installed in the control unit 250. The memory 260 can store the image data and other analysis outputs or result.

In an exemplary embodiment, the control unit 250 includes one or more processors 270. During operation of the control unit 250, the control unit 250 runs programs to analyze the images. For example, the control unit 250 operates programs stored in the memory 260 on the processor 270. The control system 200 includes the video analysis tool 202, the object detection tool 204, and the video segmenting tool 206, which may incorporate one or more of the memories 260 and one or more of the processors 270. The video analysis tool 202 is configured to define action regions in the video. The object detection tool 204 is configured to detect objects in the assembly area 110 of the video. The video segmenting tool 206 is configured to segment the video into action clips based on locations of the detected objects relative to the defined action regions for analysis.

The processor(s) 270 may include computer system executable instructions, such as program modules, being executed by a computer system. Generally, program modules may include routines, programs, objects, components, logic, data structures, and so on that perform particular tasks or implement particular abstract data types. The computing may be practiced in distributed cloud computing environments where tasks are performed by remote processing devices that are linked through a communications network. In a distributed cloud computing environment, program modules may be located in both local and remote computer system storage media including memory storage devices.

In an exemplary embodiment, various components may be communicatively coupled by a bus, such as the memory 260 and the processors 270. The bus represents one or more of any of several types of bus structures, including a memory bus or memory controller, a peripheral bus, an accelerated graphics port, and a processor or local bus using any of a variety of bus architectures.

The control unit 250 may include a variety of computer system readable media. Such media may be any available media that is accessible by the control unit 250, and it includes both volatile and non-volatile media, removable and non-removable media. The memory 260 can include computer system readable media in the form of volatile memory, such as random access memory (RAM) and/or cache memory. The control unit 250 may further include other removable/non-removable, volatile/non-volatile computer system storage media. By way of example only, a storage system can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. The memory 260 may include at least one program product having a set (e.g., at least one) of program modules that are configured to carry out the functions of embodiments of the invention.

One or more programs may be stored in the memory 260, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the subject matter described herein.

The control unit 250 may also communicate with one or more external devices, such as through the communication board 254 of the control unit 250. The external devices may include a keyboard, a pointing device, a display, and the like; one or more devices that enable a user to interact with system; and/or any devices (e.g., network card, modem, etc.) that enable the system to communicate with one or more other computing devices. Such communication can occur via Input/Output (I/O) interfaces. Still yet, the control unit 250 can communicate with one or more networks such as a local area network (LAN), a general wide area network (WAN), and/or a public network (e.g., the Internet) via network adapter. Other hardware and/or software components could be used in conjunction with the system components shown herein. Examples include, but are not limited to: microcode, device drivers, redundant processing units, and external disk drive arrays, RAID systems, tape drives, and data archival storage systems, etc.

The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 270, memory 260, and input/output interface can be interconnected, for example, via the bus as part of a data processing unit. Suitable interconnections, for example via bus, can also be provided to a network interface, such as a network card, which can be provided to interface with a computer network, and to a media interface, such as a diskette or CD-ROM drive, which can be provided to interface with suitable media.

Accordingly, computer software including instructions or code for performing the methodologies of the subject matter herein may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors. Further, a computer program product can include a computer-readable storage medium with code adapted to be implemented to carry out one or more method steps described herein, including the provision of the system with the distinct software modules.

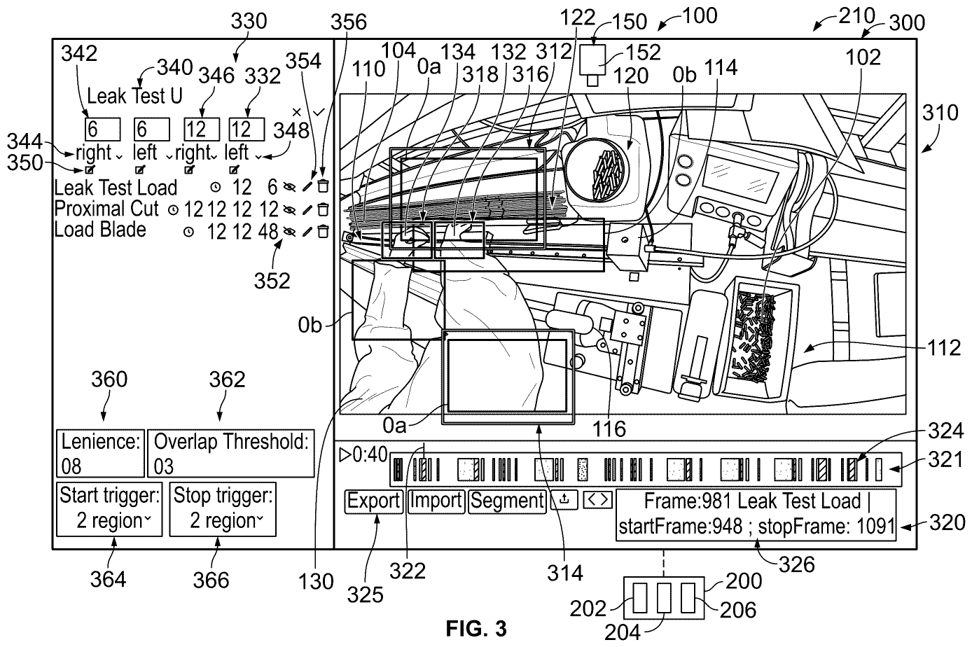

FIG. 3 illustrates the control system 200 for the part assembly workstation 100 in accordance with an exemplary embodiment. For example, FIG. 3 illustrates a display of the control system 200, such as at the display device 210. FIG. 3 shows multiple windows 300 on the display device 210. In an exemplary embodiment, the display device 210 shows a video player window 310 showing the video and a video player toolbar 320 for controlling the video player window 310. In an exemplary embodiment, the display device 210 shows a settings window 330 for controlling the control system 200. For example, different settings may be modified in the settings window 330 to control the video-based analysis and/or video segmentation of tasks/actions within the part assembly workstation 100. The settings may be modified in the settings window 330 to control the video analysis tool 202 and/or the object detection tool 204 and/or the video segmenting tool 206.

The video player window 310 shows the video(s) received from the imaging device 150. Views from one or more of the cameras 152 may be displayed in the video player window 310. The video shows the view of the assembly area 110, such as showing the parts 102, the products 104, the support structure 112, the holder 114, the assembly tool 116, the part storage 120, the product storage 122, or other components. The video show the operator 130 at the assembly area 110, such as the operators right hand 132 and left hand 134, such as to view the manual assembly of the parts 102 by the operator 130.

In an exemplary embodiment, the video player window 310 includes one or more action regions. For example, in the illustrated embodiment, the video player window 310 includes a first action region 312 and a second action region 314. The action regions 312, 314 may correspond with different assembly actions/tasks. For example, one or more assembly tasks may occur in the first action region 312 and one or more assembly tasks may occur in the second action region 314. The first action region 312 may be an action start region and the second action region 314 may be an action stop region. The video player window 310 may include greater or fewer action regions in alternative embodiments. In an exemplary embodiment, the action regions 312, 314 are defined by bounding boxes that overlay the video. Other types of action regions 312, 314 may be provided in alternative embodiments, such as opaque or shaded regions. The action regions 312, 314 are regions or sub-areas, within the assembly area 110, where one or more assembly steps occur. The action regions 312, 314 may be areas where the operators hands are located during an assembly task. The action regions 312, 314 may be areas where fixtures or assembly tools are located and where assembly of the parts occurs. The action regions 312, 314 may be defined by the video analysis tool 202. For example, the action regions 312, 314 may be automatically detected and set by performing video analysis to identify specific regions in the video where repeated tasks occur. The action regions 312, 314 may be manually set by the operator (for example, location, size, shape, etc.) in the video. In the illustrated embodiment, the action regions 312, 314 are rectangular. However, the action regions 312, 314 may have other shapes in alternative embodiments.

In an exemplary embodiment, the video player window 310 includes one or more object identification regions. For example, in the illustrated embodiment, the video player window 310 includes a first object identification region 316 and a second object identification region 318. The video player window 310 may include greater or fewer object identification regions in alternative embodiments. The object identification regions 316, 318 may correspond with different objects (for example, hands, workpieces, assembly tools, etc.). For example, the first object identification region 316 may correspond with the operators right hand and the second object identification region 318 may correspond with the operators left hand. In an exemplary embodiment, the object identification regions 316, 318 are defined by bounding boxes that overlay the video. Other types of object identification regions 316, 318 may be provided in alternative embodiments, such as opaque or shaded regions. The object identification regions may track movements of the objects within the frames of the video. The object identification regions 316, 318 may be defined by the object detection tool 204. For example, the object identification regions may be automatically detected and set by performing video analysis to identify specific regions in the video where the objects are located. In the illustrated embodiment, the object identification regions are rectangular. However, the object identification regions may have other shapes in alternative embodiments. In an exemplary embodiment, the control system 200 determines relative locations of the object identification regions 316, 318 and the action regions 312, 314 to control the system. For example, the relative locations of the object identification regions 316, 318 and the action regions 312, 314 are used for video segmentation. For example, when the objects are determined to be present within the action regions 312, 314, the control system 200 correlates such to particular assembly actions/tasks. The control system 200 segments video clips based on overlap of the object identification regions 316, 318 and the action regions 312, 314.

In an exemplary embodiment, the control system 200 determines the number of action regions. The control system 200 identifies actions/tasks to start or stop. The control system 200 determines object classifications, such as the type of object (for example, hands, workpieces, tools, and the like). For example, the control system 200 can define hand classification, such as right hand, left hand, and the like to differentiate the objects in the video. The control system 200 can specify triggers for the various action region to be either: left hand, right hand, both hands, or any hand. The control system 200 determines how many frames the hand(s) are in the action region before trigger an event. The control system 200 may use a leniency threshold for triggering the event. For instance, if the leniency threshold is 0.8, and the number of frames is 10, then as long as the satisfied number of frames is equal to or larger than 8, the action can be triggered. The control system 200 uses an overlap threshold to determine an amount of overlap of the object identification regions 316, 318 with the action regions 312, 314 to define how much portion of a hand enters the region to be considered valid for a frame. The video segmentation occurs to define the action clips based on the video analysis performed by the control system 200.

In the illustrated embodiment, the video player toolbar 320 is located below the video player window 310. The video player toolbar 320 includes a seek bar 321 having a slider 322 that indicates the frame location within the video. In an exemplary embodiment, the video player toolbar 320 includes a visualization 324 of the segmentation of the action clips within the video. The visualization 324 may be color coded to identify different types of action clips. The video player toolbar 320 includes buttons 325 to control playback of the video. The buttons 325 may include one or more of the following buttons: play, pause, stop, back, skip, rewind, fast-forward, or other buttons. The buttons 325 may include an import button and an export button to import or export videos or clips. The buttons 325 may include a segment button to manually segment clips from the video. The video player toolbar 320 includes an identification tag 326 to identify information about the video, such as a file name, the frame number, the action clip name, the action clip start frame, the action clip stop frame, or other identifying information.

The settings window 330 includes setting features 332 (or settings 332) that may be adjusted or modified to control the system. For example, the settings 332 may be modified in the settings window 330 to control the video analysis tool 202 and/or the object detection tool 204 and/or the video segmenting tool 206. The settings 332 can be used by the operator to define the action regions and the action start and stop conditions for video segmentation. The settings 332 may include tabs, drop down menus, input cells, buttons, toggles, sliders, or other types of settings. In an exemplary embodiment, the settings 332 include one or more action name cells 340, one or more action start duration cells 342, object selection menus 344 associated with the action start duration cells 342, one or more action stop duration cells 346, object selection menus 348 associated with the action stop duration cells 346, action condition toggles 350, action visibility toggle buttons 352, action edit buttons 354, action delete buttons 356, and may include other settings 332.

In an exemplary embodiment, different action names may be given to different types of actions/tasks that are performed at the part assembly workstation 100 at the action name cells 340. Any number of different tasks may be tracked by the system.

In an exemplary embodiment, the action start duration input to the cell 342 may be a select number of frames (for example, 6 frames, 12 frames, or any other reasonable number of frames) that the object (for example, hand) is in the corresponding action region (for example, the start action region 312). For example, the number of frames may be based on the particular task being performed and how long such task takes the operator to perform. The user may select the type of object being tracked in the object selection menus 344, such as right hand, left hand, part, product, assembly tool, and the like. In various embodiments, the control system may provide for selection of multiple objects in the start action region 312, such as requiring both the right and left hand in the start action region 312. The user may toggle requiring the object by selecting or unselecting the action condition toggles 350 associated with the various object selection menus 344. For example, the user may turn on/off requiring the right hand or the left hand in the action region 312 by selecting or unselecting the corresponding object selection menus 344.

In an exemplary embodiment, the action stop duration input to the cell 346 may be a select number of frames (for example, 6 frames, 12 frames, or any other reasonable number of frames) that the object (for example, hand) is in the corresponding action region (for example, the stop action region 314). For example, the number of frames may be based on the particular task being performed and how long such task takes the operator to perform. The user may select the type of object being tracked in the object selection menus 348, such as right hand, left hand, part, product, assembly tool, and the like. In various embodiments, the control system may provide for selection of multiple objects in the stop action region 314, such as requiring both the right and left hand in the start action region 314. The user may toggle requiring the object by selecting or unselecting the action condition toggles 350 associated with the various object selection menus 348. For example, the user may turn on/off requiring the right hand or the left hand in the action region 314 by selecting or unselecting the corresponding object selection menus 348.

In an exemplary embodiment, the settings 332 include a leniency threshold cell 360 where the user selects the leniency threshold for triggering the event. For instance, if the leniency threshold is 0.5 then as long as the satisfied number of frames is equal to or larger than 0.5 times the number of frames (set at the action start duration cells 342 or the action stop duration cells 346), the action can be triggered. The leniency threshold of the objects in the action regions are determined in X out of Y successive frames.

In an exemplary embodiment, the settings 332 include an overlap threshold cell 362 where the user selects the overlap threshold to determine an amount of overlap of the object identification regions 316, 318 with the action regions 312, 314 to be considered valid for a frame. For instance, if the overlap threshold is 0.5 then as long as 50% of the object overlaps with the action region, then the frame is considered to be a positive frame to trigger the action. However, if less than 50% of the object is overlapping with the action region, then the frame is considered to be a negative frame, and thus the action is not triggered by the frame.

In an exemplary embodiment, the settings 332 include a start trigger button 364 and a stop trigger button 366. The start trigger button 364 may allow setting of the number of regions used to define the start trigger condition, such as 1 region, 2 regions, 3 regions, or others. The start trigger button 364 may determine the type of action start trigger condition, such as the number of type of objects in the action regions. The start trigger button 364 may require left hand, right hand, both hands, or any hand or may require a part or tool or other object in the action region. The stop trigger button 366 may allow setting of the number of regions used to define the stop trigger condition, such as 1 region, 2 regions, 3 regions, or others. The stop trigger button 366 may determine the type of action stop trigger condition, such as the number of type of objects in the action regions. The stop trigger button 366 may require left hand, right hand, both hands, or any hand or may require a part or tool or other object in the action region. The start trigger button 364 and the stop trigger button 366 may be drop down menus.

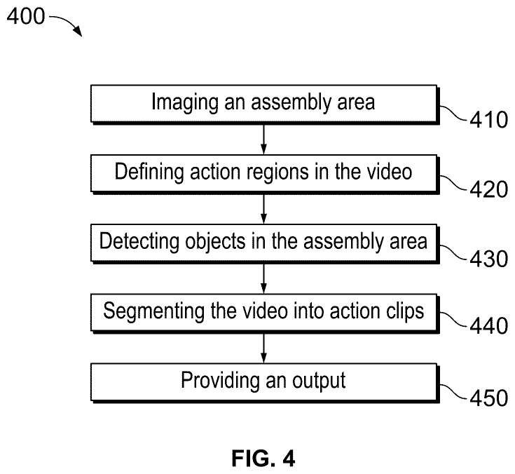

FIG. 4 is a flow chart showing a method 400 of controlling a part assembly workstation in accordance with an exemplary embodiment for assembling parts.

At 410, the method includes imaging an assembly area of the part assembly workstation with at least one imaging device to create a video of the assembly area during assembly processes. The imaging may include setting up one or more cameras to image the assembly area, such as to view one or more assembly tasks. The cameras may view the assembly area from above to image the assembly of the parts into the product. The cameras may view assembly tools, fixtures, part storage bins, the parts, the assembled product, the operators hands, or other objects in the assembly area during the assembly process. The cameras may track movement of the objects in the assembly area.

At 420, the method includes defining action regions in the video. The action regions are subsets of the assembly area. The action regions may correspond with regions of the assembly area where assembly actions of the parts occur. For example, the action regions may correspond with areas where one part is inserted into another part or fixed to another part. In various embodiments, the step of defining action regions includes positioning action region bounding boxes in the video at designated locations. For example, the operator may draw or insert one or more bounding boxes in the video at the action regions. The control system may automatically determine the action regions. For example, the control system may provide video analysis using a video analysis tool to determine the locations of the action regions in the video. The action region bounding boxes may have a predetermined shape, such as a rectangular shape; however, the action region bounding boxes are not limited to a rectangular shape. The control system may analyze the video to determine the locations of the action regions (for example, based on repeated actions or based on locations of tools, fixtures, or other components identified in the images). In various embodiments, the action regions may be in non-overlapping areas of the video. In other various embodiments, the action regions may be overlapping areas within the video, such as when different action tasks occur in the same or similar areas.

At 430, the method includes detecting objects in the assembly area of the video. The control system may automatically detect objects in the assembly area. For example, the control system may provide video analysis using an object detection tool to determine the locations of the objects in the video. In various embodiments, the detected objects are the hands/arms of the operator. The detected objects may be the workpieces (for example, the parts and/or products). The detected objects may be an assembly tool, fixture, robot arm, or other device used during the manufacturing process. The control system may track movement of the objects through the various frames of the video. In various embodiments, the step of detecting the objects includes performing shape analysis of the video to identify objects having predetermined shapes. For example, the shapes may correspond to the shapes of a person's hands or the shapes of the workpieces or the shapes of the assembly tools. In various embodiments, the step of detecting the objects includes performing color analysis of the video to identify objects having predetermined colors. For example, the colors may correspond to the colors of gloves worn by a person to easily track the person's hands in the vide or the colors of the parts to easily track the locations of the parts in the video. In various embodiments, the step of detecting the objects includes positioning object bounding boxes in the video around the objects. The object bounding boxes may have a predetermined shape, such as a rectangular shape; however, the object bounding boxes are not limited to a rectangular shape.

At 440, the method includes segmenting the video into action clips based on locations of the detected objects relative to the defined action regions. The segmentation of the action clips may be based on the number of action regions and types of the objects located in the action regions. The segmentation may be based on locations of the action region bounding boxes and locations of the object bounding boxes. For example, the segmentation may be based on overlapping of the object bounding boxes and the action region bounding boxes indicative of the objects being located in the action regions. The step of segmenting the video includes determining frames of the video in which the objects are located in the action regions. In various embodiments, the segmenting step includes segmenting the video into action clips corresponding to different actions of the assembly process. For example, the assembly process may involve multiple assembly steps and the video may be segmented into the different assembly steps. In various embodiments, the segmenting step includes determining an action commencing frame from the frames of the video and determining an action concluding frame from the frames of the video. Each action clip may include multiple frames. For example, the action clip includes the frames of the video commencing at the action commencing frame and concluding at the action concluding frame. In an exemplary embodiment, the action commencing frame is determined as the frame in which the objects are located inside the action regions and the action concluding frame is determined as the frame in which the objects are located outside of the action regions.

In various embodiments, the defining action regions step includes positioning action region bounding boxes in the video at designated locations and the detecting objects step includes positioning object bounding boxes in the video around the objects. The method may include the step of determining an amount of overlap of the object bounding boxes with the action region bounding boxes in each frame. The method may include the step of setting an overlap threshold for the object bounding box and the action region bounding box. In an exemplary embodiment, the segmenting step includes segmenting the video into action clips based on the overlap threshold of the objects and the action regions. For example, the overlap threshold may be an overlap threshold of at least 50%, wherein the object is considered in the action region when at least 50% of the object bounding box overlaps with the action region bounding box. The overlap threshold may be adjusted by the operator to increase or decrease the sensitivity of the video segmentation. The method may include the step of setting a leniency threshold for the actions. In an exemplary embodiment, the segmenting step includes segmenting the video into action clips based on the leniency threshold of the objects in the action regions. For example, the leniency threshold may correspond to the number of frames in a set of frames in which the object is identified as being in the action region. For example, in various embodiments, the leniency threshold may require identification of the object in the action region in X out of Y successive frames, where X is at least 0.5Y. The leniency threshold may be adjusted by the operator to increase or decrease the sensitivity of the video segmentation.

At 450, the method includes providing an output from the control system. The method may include outputting the segmented video clips. The method may include outputting a spreadsheet showing durations of the action clips and/or start frames and end frames of the action clips and/or number of occurrences of the various actions/tasks in the video. The method may include outputting a visualization of the segmented results. For example, the visualization may be a time graph corresponding to the video. The visualization may be color coded to show the occurrence of different actions/tasks.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A method of controlling a part assembly workstation for assembling parts, the method comprising:
imaging an assembly area of the part assembly workstation with at least one imaging device to create a video of the assembly area during assembly processes;
defining action regions in the video, the action regions being subsets of the assembly area;
detecting objects in the assembly area of the video; and
segmenting the video into action clips based on locations of the detected objects relative to the defined action regions.

2. The method of claim 1, wherein the action regions correspond with regions of the assembly area where assembly actions of the parts occur.

3. The method of claim 1, wherein said defining action regions comprises positioning action region bounding boxes in the video at designated locations.

4. The method of claim 1, wherein the assembly area includes an assembly tool, said defining action regions comprises defining action regions corresponding to the location of the assembly tool.

5. The method of claim 1, wherein said defining action regions includes positioning the action regions in non-overlapping areas of the video.

6. The method of claim 1, wherein said detecting objects comprises detecting positions of hands of an operator in the video.

7. The method of claim 1, wherein said detecting objects comprises shape analysis of the video for objects having predetermined shapes.

8. The method of claim 1, wherein said detecting objects comprises color analysis of the video for objects having predetermined colors.

9. The method of claim 1, wherein said detecting objects includes positioning object bounding boxes in the video around the objects.

10. The method of claim 1, wherein said detecting objects includes tracking the objects in each frame of the video.

11. The method of claim 1, wherein said segmenting the video includes determining frames of the video in which the objects are located in the action regions.

12. The method of claim 1, wherein said segmenting includes segmenting the video into action clips corresponding to different actions of the assembly process.

13. The method of claim 1, wherein said segmenting includes determining an action commencing frame from the frames of the video and determining an action concluding frame from the frames of the video, the action clips including the frames of the video commencing at the action commencing frame and concluding at the action concluding frame.

14. The method of claim 13, wherein the action commencing frame is determined as the frame in which the objects are located inside the action regions and the action concluding frame is determined as the frame in which the objects are located outside of the action regions.

15. The method of claim 1, wherein said defining action regions comprises positioning action region bounding boxes in the video at designated locations and said detecting objects includes positioning object bounding boxes in the video around the objects, the method further comprising determining an amount of overlap of the object bounding boxes with the action region bounding boxes in each frame.

16. The method of claim 1, wherein said segmenting includes segmenting the video into action clips based on an overlap threshold of the objects and the action regions.

17. The method of claim 1, wherein said segmenting includes segmenting the video into action clips based on a leniency threshold of the objects in the action regions in X out of Y successive frames, where X is at least 0.5Y.

18. The method of claim 1, further comprising outputting a spreadsheet showing durations of the action clips.

19. The method of claim 1, further comprising outputting a visualization of the segmented results.

20. The method of claim 1, wherein said segmenting includes segmenting the video clip into action clips based on the number of action regions and types of the objects located in the action regions.

21. A control system for a part assembly workstation comprising:
an imaging device at an assembly area of the part assembly workstation where parts are assembled to create a product, the imaging device creates a video of the assembly area during the assembly processes;
a video analysis tool having one or more processors configured to define action regions in the video, the action regions being subsets of the assembly area;
an object detection tool having one or more processors configured to detect objects in the assembly area of the video; and
a video segmenting tool having one or more processors configured to segment the video into action clips based on locations of the detected objects relative to the defined action regions.

22. A part assembly workstation comprising:
an assembly area where parts are assembled to create a product;
an imaging device at the assembly area, the imaging device creating a video of the assembly area during the assembly processes; and
a control system receiving the video from the imaging device, the control system including a video analysis tool, an object detection tool, and a video segmenting tool;
the video analysis tool having one or more processors configured to define action regions in the video, the action regions being subsets of the assembly area;
the object detection tool having one or more processors configured to detect objects in the assembly area of the video; and
the video segmenting tool having one or more processors configured to segment the video into action clips based on locations of the detected objects relative to the defined action regions.
